(19) United States
(12) Patent Application Publication
(10) Pub. No.: US 2016/0282949 A1
(43) Pub. Date: Sep. 29, 2016

(54) METHOD AND SYSTEM FOR DETECTING LINEAR SWIPE GESTURE USING ACCELEROMETER

(71) Applicant: Sony Corporation, Tokyo (JP)

(72) Inventors: Magnus Midholt, Lund (SE); Ola Thorn, Limhamn (SE)

(21) Appl. No.: 14/670,633

(22) Filed: Mar. 27, 2015

(51) Int. Cl. G06F 3/01; G06F 1/16; G01P 15/00

(52) U.S. Cl. CPC G06F 3/017; G01P 15/00; G06F 1/163

(57) ABSTRACT

A device and method detect user input for an electronic device based on linear acceleration and/or linear acceleration rate of the electronic device. More particularly, at least one of linear acceleration or linear acceleration rate of the electronic device is detected, the detected linear acceleration or acceleration rate is correlated to a gesture for controlling the electronic device.

### TECHNICAL FIELD OF THE INVENTION

The technology of the present disclosure relates generally to electronic devices and, more particularly, to an apparatus and method for detecting linear swipe gestures using an accelerometer.

### BACKGROUND

Electronic devices, such as mobile phones, smart watches, cameras, music players, notepads, etc., are becoming increasingly popular. For example, smart watches, in addition to providing a means for keeping time, provide a number of other features, such as text messaging, email, camera functions, the ability to execute applications, etc.

Conventionally, a user may input commands to an electronic device via a touch screen. Electronic devices in the form of smart watches or other wearable devices, however, tend to have limited space available for the touch screen. As a result, interaction with the touch screen can occlude the display from the user's view.

### SUMMARY

A device and method in accordance with the present disclosure enable wearable electronic devices, such as smart watches or other devices having a relatively small display device (or no display device), to detect user gesture commands for controlling the electronic device. More particularly, the electronic device and method in accordance with the present disclosure can detect swipe gestures performed, for example, on the user's arm (or other location near the electronic device). Preferably, the gestures are detected based on acceleration (e.g., linear acceleration) of the electronic device, which can be detected, for example, using an accelerometer of the electronic device, a gyroscope of the electronic device and/or software calculations. Based on the determined linear acceleration, the gesture performed by the user can be identified and used to operate the electronic device.

According to one aspect of the invention, an electronic device includes: a linear acceleration sensor; a control circuit operatively coupled to the linear acceleration sensor, the control circuit configured to detect at least one of linear acceleration or a linear acceleration rate of the electronic device based on data provided by the linear acceleration sensor, and correlate the detected linear acceleration or linear acceleration rate to an input command for controlling the electronic device.

According to one aspect of the invention, a method for detecting user inputs for an electronic device includes: detecting at least one of a linear acceleration or a linear acceleration rate of the electronic device; and correlating the detected linear acceleration or linear acceleration rate to a gesture for controlling the electronic device.

To the accomplishment of the foregoing and the related ends, the device and method comprises the features hereinafter fully described in the specification and particularly pointed out in the claims, the following description and the annexed drawings setting forth in detail certain illustrative embodiments, these being indicative, however, of but several of the various ways in which the principles of the invention may be suitably employed.

Although the various features are described and are illustrated in respective drawings/embodiments, it will be appreciated that features of a given drawing or embodiment may be used in one or more other drawings or embodiments of the invention.

### BRIEF DESCRIPTION OF THE DRAWINGS

FIG. 1 is a schematic diagram illustrating an electronic device in the form of a smart watch, where gesture commands are detected based on linear acceleration of the electronic device.

FIG. 2 is a schematic diagram illustrating a system that may implement an input detection function in accordance with the present disclosure.

FIG. 3 is a schematic block diagram of modules of an electronic device that implements an input detection function in accordance with the present disclosure.

FIG. 4 is a flow chart illustrating exemplary steps for implementing an input detection function in accordance with the present disclosure.

### DETAILED DESCRIPTION OF EMBODIMENTS

Embodiments will now be described with reference to the drawings, wherein like reference numerals are used to refer to like elements throughout. It will be understood that the figures are not necessarily to scale. Additionally, features that are described and/or illustrated with respect to one embodiment may be used in the same way or in a similar way in one or more other embodiments and/or in combination with or instead of the features of the other embodiments.

Described below in conjunction with the appended figures are various embodiments of an apparatus and a method for detecting gesture inputs to an electronic device. While embodiments in accordance with the present disclosure relate, in general, to the field of electronic devices, for the sake of clarity and simplicity most embodiments outlined in this specification are described in the context of smart watch. It should be appreciated, however, that features described in the context of smart watches are also applicable to other wearable electronic devices. Therefore, the techniques described in this document may be applied to any type of wearable electronic device, examples of which include a smart watch, a head set, a media player, a gaming device, a communicator, a portable communication apparatus, a bracelet, visors, a phone attached to the arm, a ring, etc. that may be attached to the arm, finger, neck, leg, etc.

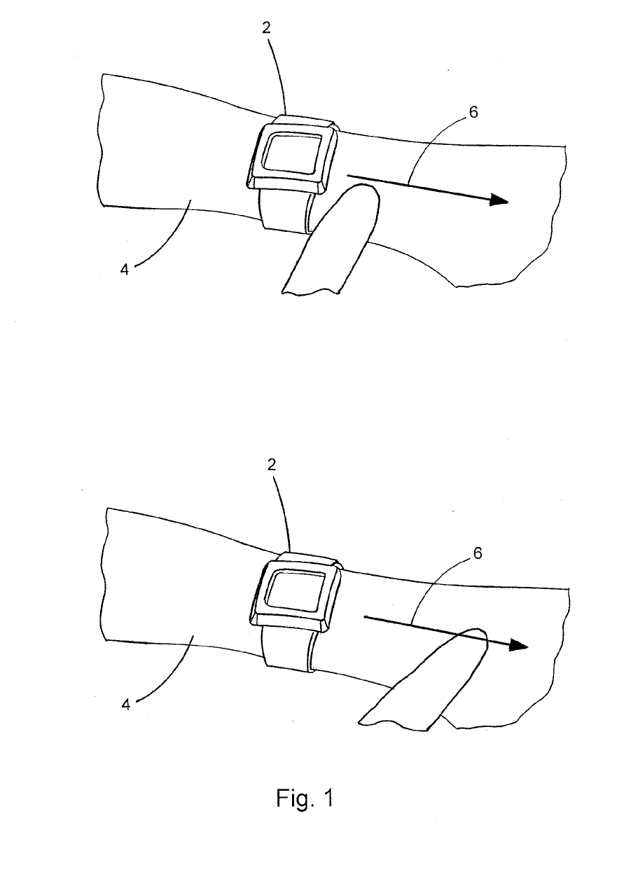

In accordance with the present disclosure, gestures are detected based on linear acceleration of the electronic device. For example, and with reference to FIG. 1, an electronic device 2 in the form of a smart watch is worn on the wrist of a user's arm 4. Using a finger (e.g., the right index finger or other finger), pointing device or the like, the user performs a left-to-right swiping gesture 6 on a surface of his arm 4 in the vicinity of the smart watch 2. The exemplary gesture 6, which begins near the smart watch 2, travels in a direction along an axis of the user's arm 4 away from the smart watch 2. The gesture 6 causes the user's skin to deform in a direction of the swiping motion, which in turn causes the smart watch 2 to move along the same axis.

While a left-to-right gesture is shown, it will be appreciated that other linear path gestures are possible. For example, the gesture can be right-to-left along the arm axis (e.g., the X-axis), top-to-bottom or bottom-to-top (e.g., the Y-axis), in-to-out or out-to-in (e.g., the Z-axis), or a combination along the X, Y and Z axes.

The motion can be detected by monitoring a linear acceleration of the smart watch 2. In one embodiment, an accelerometer is used to detect acceleration of the smart watch and/or an acceleration rate of the smart watch. The data obtained from the accelerometer can be processed via a conventional algorithm to obtain the linear acceleration of the smart watch 2 and/or the acceleration rate of the smart watch.

Accelerometers provide information about linear movement as a sum of linear and centripetal acceleration affected by gravity and vibration. Extraction of a single element from the linear motion information given by accelerometer generally requires an addition of device able to provide detailed information about rotational movement. In another embodiment, sensor fusion is implemented in the smart watch, where data from both the accelerometer and another sensor, such as a magnetometer, are combined (fused). In this regard, the magnetometer can enable extraction of the linear acceleration.

A magnetometer provides an intuitive solution for providing rotational movement information required for a complete motion processing solution. However, the magnetometer output data is relative to magnetic north, can be prone to effects of external magnetic field sources, and may have limited ability to respond to fast rotational movements.

In a preferred embodiment, the smart watch 2 may include both an accelerometer and a gyroscope, where data from both sensors are used to determine the linear acceleration and/or acceleration rate of the smart watch. The accuracy provided by sensor fusion of an accelerometer and gyroscope is greater than that of an accelerometer alone and more reliable than the results provided by the accelerometer in combination with the magnetometer.

The linear acceleration and/or acceleration rate data obtained from the sensor(s) then is analyzed to determine a direction of the swipe (e.g., X-axis, Y-axis, and/or Z-axis) and/or an intensity of the swipe. The determined direction and/or intensity then can be communicated to an application, which may use the direction and/or intensity of the gesture to generate various commands within the smart watch 2. For example, scrolling functions, selecting functions, navigations functions, etc. may be implemented by the application.

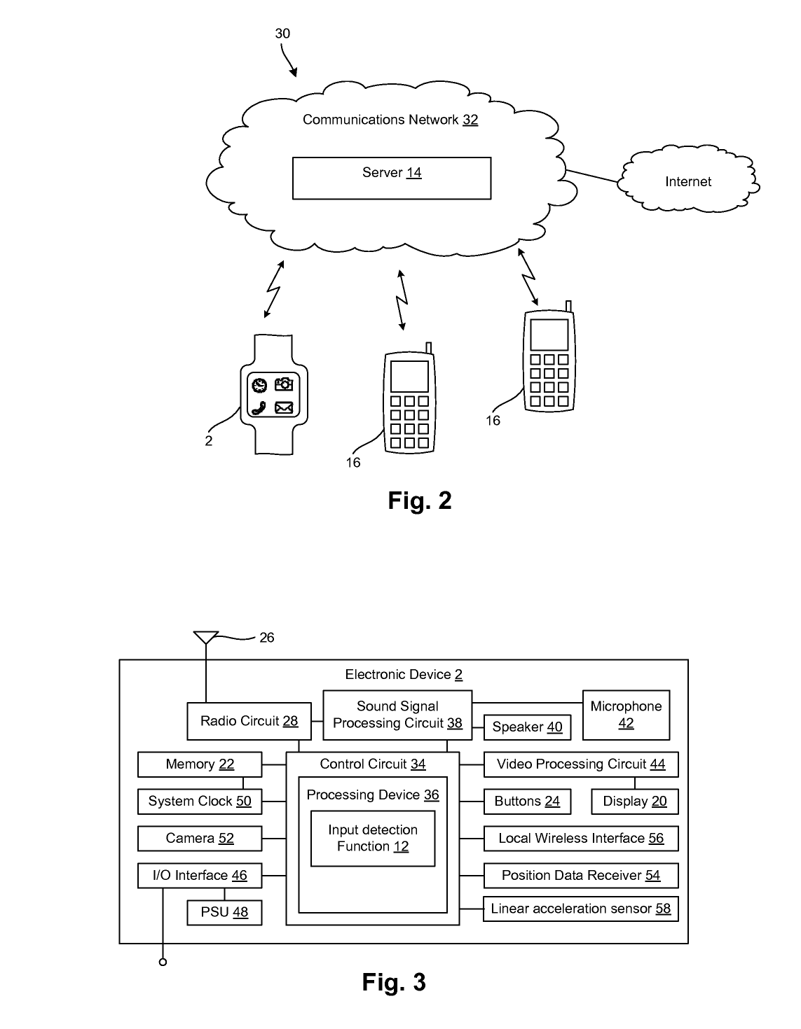

Referring now to FIGS. 2 and 3, an electronic device 2 is shown. In one embodiment the electronic device 2 includes at least a portion of an input detection function 12 that is configured to detect gestures performed by the user based on linear acceleration of the electronic device 10. In another embodiment the electronic device 2 may operatively communicate with a server 14, the server 14 including at least a portion of the input detection function 12 to process the linear acceleration data collected by the electronic device 2.

Additional details and operation of the input detection function 12 will be described in greater detail below. The input detection function 12 may be embodied at least partially as executable code that is resident in and executed by the electronic device 2 and/or server 14. In one embodiment, the input detection function 12 may be one or more programs that are stored on a computer or machine readable medium. The input detection function 12 may be a stand-alone software application or form a part of a software application that carries out additional tasks related to the electronic device 2.

Through the following description, exemplary techniques for detecting gestures performed by a user are described. It will be appreciated that through the description of the exemplary techniques, a description of steps that may be carried out in part by executing software is described. The described steps are the foundation from which a programmer of ordinary skill in the art may write code to implement the described functionality. As such, a computer program listing is omitted for the sake of brevity. However, the described steps may be considered a method that the corresponding device is configured to carry out. Also, while the input detection function 12 may be implemented in software in accordance with an embodiment, such functionality could also be carried out via dedicated hardware or firmware, or some combination of hardware, firmware and/or software.

The electronic device 2 may include a display 20. The display 20 displays information to a user such as operating state, time, telephone numbers, contact information, various menus, etc., that enable the user to utilize the various features of the electronic device 2. The display 20 also may be used to visually display content received by the electronic device 2 and/or retrieved from a memory 22 of the electronic device 2. The display 20 may be used to present images, video and other graphics to the user, such as photographs, mobile television content, Internet pages, and video associated with games.

Buttons 24 provide for a variety of user input operations, and in an electronic device embodied as a smart watch may be arranged along a side or edge of the smart watch. For example, the buttons 24 may include buttons for allowing entry of information, special function buttons (e.g., one or more of a call send and answer button, multimedia playback control buttons, a camera shutter button, etc.), navigation and select buttons or a pointing device, and so forth. Buttons or button-like functionality also may be embodied as a touch screen associated with the display 20. Also, the display 20 and buttons 24 may be used in conjunction with one another to implement soft key functionality.

The electronic device 2 includes communications circuitry that enables the electronic device 2 to establish communications with another device. Communications may include calls, data transfers, and the like. Calls may take any suitable form such as, but not limited to, voice calls and video calls. The calls may be carried out over a cellular circuit-switched network or may be in the form of a voice over Internet Protocol (VoIP) call that is established over a packet-switched capability of a cellular network or over an alternative packet-switched network (e.g., a network compatible with IEEE 802.11, which is commonly referred to as WiFi, or a network compatible with IEEE 802.16, which is commonly referred to as WiMAX), for example. Data transfers may include, but are not limited to, receiving streaming content (e.g., streaming audio, streaming video, etc.), receiving data feeds (e.g., pushed data, podcasts, really simple syndication (RSS) data feeds data feeds), downloading and/or uploading data (e.g., image files, video files, audio files, ring tones, Internet content, etc.), receiving or sending messages (e.g., text messages, instant messages, electronic mail messages, multimedia messages), and so forth. This data may be processed by the electronic device 2, including storing the data in the memory 22, executing applications to allow user interaction with the data, displaying video and/or image content associated with the data, outputting audio sounds associated with the data, and so forth.

In the exemplary embodiment, the communications circuitry may include an antenna 26 coupled to a radio circuit 28. The radio circuit 28 includes a radio frequency transmitter and receiver for transmitting and receiving signals via the antenna 26.

The radio circuit 28 may be configured to operate in a mobile communications system 30 (FIG. 2). Radio circuit 28 types for interaction with a mobile radio network and/or broadcasting network include, but are not limited to, global system for mobile communications (GSM), code division multiple access (CDMA), wideband CDMA (WCDMA), general packet radio service (GPRS), WiFi, WiMAX, digital video broadcasting-handheld (DVB-H), integrated services digital broadcasting (ISDB), high speed packet access (HSPA), etc., as well as advanced versions of these standards or any other appropriate standard. It will be appreciated that the electronic device 2 may be capable of communicating using more than one standard. Therefore, the antenna 26 and the radio circuit 28 may represent one or more than one radio transceiver.

The system 30 may include a communications network 32 having the server 14 (or servers) for managing calls placed by and destined to the electronic device 2, transmitting data to and receiving data from the electronic device 2 and carrying out any other support functions. The server 14 communicates with the electronic device 2 via a transmission medium. The transmission medium may be any appropriate device or assembly, including, for example, a communications base station (e.g., a cellular service tower, or “cell” tower), a wireless access point, a satellite, etc. The network 32 may support the communications activity of multiple electronic devices (e.g., smart watch 2, mobile phone 16) and other types of end user devices. As will be appreciated, the server 14 may be configured as a typical computer system used to carry out server functions and may include a processor configured to execute software containing logical instructions that embody the functions of the server 14 and a memory to store such software and any related databases. In alternative arrangements, the electronic device 2 may wirelessly communicate directly with another electronic device 2 (e.g., another mobile telephone or a computer) and without an intervening network. As indicated, the server 14 may store and execute the input detection function 12. In another embodiment, communications activity of the electronic devices 2, 16 may be managed by a server that is different from the server 14 that executes the input detection function 12.

The electronic device 2 may include a primary control circuit 34 that is configured to carry out overall control of the functions and operations of the electronic device 2. The control circuit 34 may include a processing device 36, such as a central processing unit (CPU), microcontroller or microprocessor. The processing device 36 executes code stored in a memory (not shown) within the control circuit 34 and/or in a separate memory, such as the memory 22, in order to carry out operation of the electronic device 2. For instance, the processing device 36 may execute code that implements the input detection function 12. The memory 22 may be, for example, one or more of a buffer, a flash memory, a hard drive, a removable media, a volatile memory, a non-volatile memory, a random access memory (RAM), or other suitable device. In a typical arrangement, the memory 22 may include a non-volatile memory for long term data storage and a volatile memory that functions as system memory for the control circuit 34. The memory 22 may exchange data with the control circuit 34 over a data bus. Accompanying control lines and an address bus between the memory 22 and the control circuit 34 also may be present.

The electronic device 2 further includes a sound signal processing circuit 38 for processing audio signals transmitted by and received from the radio circuit 28. Coupled to the sound processing circuit 38 are a speaker 40 and a microphone 42 that enable a user to listen and speak via the electronic device 2. The radio circuit 28 and sound processing circuit 38 are each coupled to the control circuit 34 so as to carry out overall operation. Audio data may be passed from the control circuit 34 to the sound signal processing circuit 38 for playback to the user. The audio data may include, for example, audio data from an audio file stored by the memory 22 and retrieved by the control circuit 34, or received audio data such as in the form of voice communications or streaming audio data from a mobile radio service. The sound processing circuit 38 may include any appropriate buffers, decoders, amplifiers and so forth.

The display 20 may be coupled to the control circuit 34 by a video processing circuit 44 that converts video data to a video signal used to drive the display 20. The video processing circuit 44 may include any appropriate buffers, decoders, video data processors and so forth. The video data may be generated by the control circuit 34, retrieved from a video file that is stored in the memory 22, derived from an incoming video data stream that is received by the radio circuit 28 or obtained by any other suitable method.

The electronic device 2 may further include one or more input/output (I/O) interface(s) 46. The I/O interface(s) 46 may be in the form of typical smart watch I/O interfaces and may include one or more electrical connectors. The I/O interfaces 46 may form one or more data ports for connecting the electronic device 2 to another device (e.g., a computer) or an accessory (e.g., a personal hands free (PHF) device) via a cable.

Further, operating power may be received over the I/O interface(s) 46 and power to charge a battery of a power supply unit (PSU) 48 within the electronic device 2 may be received over the I/O interface(s) 46. The PSU 48 may supply power to operate the electronic device 2 in the absence of an external power source.

The electronic device 2 also may include various other components. For instance, a system clock 50 may clock components such as the control circuit 34 and the memory 22. A camera 52 may be present for taking digital pictures and/or movies. Image and/or video files corresponding to the pictures and/or movies may be stored in the memory 22. A position data receiver 54, such as a global positioning system (GPS) receiver, Galileo satellite system receiver or the like, may be involved in determining the position of the electronic device 2. A local wireless interface 56, such as an infrared transceiver and/or an RF transceiver (e.g., a Bluetooth chipset) may be used to establish communication with a nearby device, such as an accessory (e.g., a PHF device), another mobile radio terminal, a computer or another device.

The electronic device also includes a linear acceleration sensor 58 for detecting a linear acceleration and/or acceleration rate of the electronic device 2. In one embodiment, the linear acceleration sensor includes an accelerometer, where based on data from the accelerometer in conjunction with an algorithm executed by the control circuit 34, the linear acceleration and/or acceleration rate of the electronic device can be ascertained. In another embodiment, the linear acceleration sensor includes and accelerometer and a gyroscope, where linear acceleration and/or acceleration rate can be deduced from the combination of the data provided by the accelerometer and the gyroscope. The process of calculating linear acceleration and acceleration rate is well known in the art and therefore is not described in detail herein.

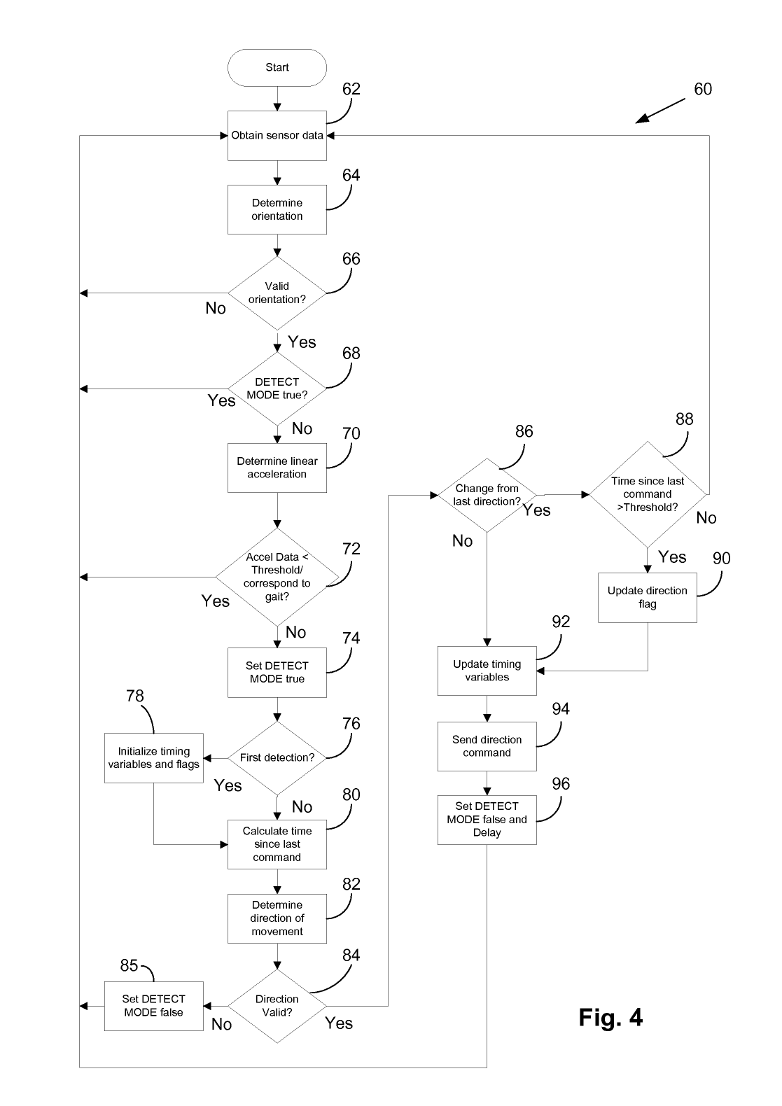

With additional reference to FIG. 4, illustrated are logical operations 60 to implement an exemplary method of detecting gestures with an electronic device based on linear acceleration data. The exemplary method may be carried out by executing an embodiment of the input detection function 12, for example. Thus, the flow chart of FIG. 4 may be thought of as depicting steps of a method carried out by one of the electronic devices 2, 16. Although FIG. 4 shows a specific order of executing functional logic blocks, the order of executing the blocks may be changed relative to the order shown. Also, two or more blocks shown in succession may be executed concurrently or with partial concurrence. Certain blocks also may be omitted.

In one embodiment, the input detection function 12 may be implemented only with portable electronic devices, such as smart watches and headsets. In another embodiment, the input detection function may be implemented with both portable electronic devices and relatively stationary electronic devices, such as desktop computers, servers, or the like.

Regardless of device type, the logical flow for input detection function may begin in block 62 where sensor data is collected from the linear acceleration sensor 58. The data may include acceleration data provided by an accelerometer of the electronic device 2 and/or gyroscope data provided by a gyroscope of the electronic device 2. At step 64 the data is processed to determine an orientation of the electronic device. For example, the gravity associated with the X, Y and Z axes can be compared to prescribed thresholds that match normal rotation (orientation) of the electronic device 10 when viewing a display of the electronic device. Alternatively, a rotation vector output from sensor fusion (Quaternion) can be compared to prescribed thresholds corresponding to normal rotation (orientation) of the electronic device 10 when viewing the display of the electronic device to map the desired device rotation.

Once the orientation is determined, it is compared to a range of acceptable orientations. For example, in the case of an electronic device embodied as a smart watch 2 a user typically views the smart watch display prior to and during entry of commands to the smart watch 2. In order to do so, the smart watch 2 generally is horizontally oriented or at some prescribed angle relative to horizontal (e.g., within 20 degrees of horizontal). Therefore, any orientation that does not fall within the prescribed range of orientations can be regarded as non-input orientation of the smart watch and thus any data indicative of a gesture input can be disregarded. For situations in which the user is not in an upright or prone position, different thresholds may be used to detect when the orientation is within a desired range.

Similarly, for an electronic device embodied as a headset the orientation may also vary about a prescribed range around horizontal (preferably a different range from that of a smart watch). Thus, any orientation that does not fall within the prescribed range of orientations can be regarded as non-input orientation of the headset and thus any data indicative of a gesture input can be disregarded. As will be appreciated, the specific range of orientations corresponding to user input will depend on the type of electronic device.

Accordingly, at step 66 if the orientation is not a valid orientation, no further analysis is needed and the method loops back to step 62. However, if the orientation of the electronic device is within the prescribed range of orientations, the method moves to step 68.

At step 68, it is determined if the electronic device 2 is presently in a detection mode. In this regard, a DETECT MODE flag provides an indication of whether or not a detect operation is active or inactive. A purpose of the DETECT MODE flag is to ensure that the algorithm is not run while a previous detect operation is still running. Accordingly, if at step 68 the DECTECT MODE flag is true, the method loops back to step 62, while if the DETECT MODE flag is false the method moves to step 70.

At step 70, the sensor data is used to calculate the linear acceleration and/or acceleration rate of the electronic device 2. As noted above, determination of linear acceleration and acceleration rate from an accelerometer or a combination of an accelerometer and a gyroscope is well known to the person having ordinary skill in the art and thus will not be described in detail herein. Briefly, acceleration is equal to gravity plus linear acceleration and, thus, linear acceleration is equal to acceleration minus gravity. A low pass filter may be employed to filter the acceleration component to extract the gravity component, thus leaving the linear acceleration.

Next at step 72, it is determined if the linear acceleration of the electronic device 2 exceeds a prescribed threshold and/or corresponds to a gait of the user. For example, as a user is walking he/she may glance at the smart watch 2 to determine the time. In this situation, the smart watch 2 will be in the proper orientation (e.g., within a prescribed range of horizontal) and the smart watch may be undergoing linear acceleration (e.g., due to the user's gait). By checking the degree and/or character of the linear acceleration (e.g., small acceleration and/or acceleration that oscillates at a frequency corresponding to user gait), certain types of linear acceleration can be disregarded as an input. If at step 72 the linear acceleration is below the prescribed threshold and/or corresponds to a gait of the user, then the data is ignored and the method moves back to step 62 and repeats. However, if the linear acceleration is greater than the prescribed threshold and/or does not correspond to the user's gait, the method moves to step 74 where the DETECT MODE flag is set true.

At step 76, it is determined if the current detected input is the first detection of a possible input or if previous inputs have already between detected. This may be implemented, for example, by checking the status of flag FIRSTDETECT, which upon initialization of the electronic device 2 may be set true. If at step 76 FIRSTDETECT is true, the method moves to step 78 where timers and flags are set/initialized. The timers may include CURRENT_TIME, which represents the time the most recent (current) input command is detected, and the variable PREV_TIME, which represents the time an input command was detected prior to the current input command. Also, the flags include PREV_DIRECTION, which represents the direction of the input command corresponding to PREV_TIME, and the aforementioned FIRST DETECT. If at step 76 FIRSTDETECT is true, the method moves to step 78 where CURRENT_TIME and PREV_TIME are set to the time at which step 78 was executed, the flag FIRSTDETECT is set false and the flag PREV_DIRECTION is set to none. The method then moves to step 80, which is discussed below.

Moving back to step 76, if the detected input is not a first detection of an input (FIRSTDETECT is false), the method bypasses step 78 and moves to step 80 where a calculation is performed with respect to the time elapsed since the last command had been detected. For example, the value stored in PREV_TIME can be subtracted from the value stored in CURRENT_TIME to determine the time elapsed since the last input has been detected (during a first detection, the difference will be zero as the respective variables are set to the same value).

Next at step 82 the direction of the gesture is determined. For example, if the linear acceleration is in the positive direction, this can be correlated to a gesture spanning left-to-right, while if the determined linear acceleration is in the negative direction, this can be correlated to a gesture spanning right-to-left. It is noted that the detected direction is not limited to a particular axis, and may include X, Y and Z components.

At step 84, the detected direction as determined at step 82 is checked to confirm the direction falls within an expected range of directions. In other words, it is determined at step 84 if the determined direction is a valid direction. If the direction is not a valid direction (i.e., the detected direction is not within a predetermined range of permissible directions), the method moves to step 85 where the DETECT MODE flag is set false. The method then moves back to step 62 and repeats. If the detected direction does fall within a range or permissible directions, the method moves to step 86 where it is determined if the direction of the gesture is different from the direction of the last detected gesture. In this regard, the value of PREV_DIRECTION can be compared to the detected direction and if they match it can be concluded that the directions are the same, while if they do not match then it can be concluded that the directions are not the same.

If there has been a change in direction the method moves to step 88 where the time elapsed since the last detected command is compared to a time threshold. A purpose of step 88 is to prevent a false direction change due to bounce in the linear acceleration. If the time since the last command is not greater than the threshold, then the command is ignored and the method moves back to step 62. However, if the time since the last command is greater than the threshold, the method moves to step 90 where the direction flag PREV_DIRECTION is updated to the detected direction, and the method moves to step 92.

Moving back to step 86, if a direction change is not detected, the method moves to step 92 where the timing variable PREV_TIME is set to the value of CURRENT_TIME. The method then moves to step 94 where the command corresponding to the detected gesture is sent to the appropriate application for further processing (e.g., to scroll a display, activate a function, etc.). Then at step 96 the flag DETECT MODE is set false, and a delay (which may be application specific) is introduced prior to returning to step 62.

Accordingly, the apparatus and method in accordance with the present disclosure enable detection of gestures based on linear acceleration and/or acceleration rate of the electronic device. The device and method are advantageous for a number of reasons. First, additional hardware is not required, as electronic devices normally include accelerometers and/or gyroscopes and, thus, there is no increase in hardware cost. Further, the device and method enable detection of gestures away from the electronic device's display, thus providing the user with a clear view of the displayed information.

Although certain embodiments have been shown and described, it is understood that equivalents and modifications falling within the scope of the appended claims will occur to others who are skilled in the art upon the reading and understanding of this specification.

1. An electronic device, comprising:
a linear acceleration sensor;
a control circuit operatively coupled to the linear acceleration sensor, the control circuit configured to detect at least one of linear acceleration or a linear acceleration rate of the electronic device based on data provided by the linear acceleration sensor, and correlate the detected linear acceleration or linear acceleration rate to an input command for controlling the electronic device.

2. The electronic device according to claim 1, wherein the linear acceleration sensor comprises an accelerometer, and accelerometer and a gyroscope, or an accelerometer and a magnetometer.

3. The electronic device according to claim 1, wherein the electronic device comprises a smart watch or a headset.

4. The electronic device according to claim 1, wherein the control circuit is configured to determine a direction of the gesture based on a direction of the linear acceleration.

5. The electronic device according to claim 4, wherein the control circuit is configured to determine the direction of the gesture in at least two different axes.

6. The electronic device according to claim 1, wherein the control circuit is configured to:
ignore linear acceleration data that is below a prescribed threshold acceleration; or
ignore linear acceleration data corresponding to a gait of a user.

7. The electronic device according to claim 1, wherein the control circuit is configured to ignore linear acceleration data that is not within a prescribed range of directions.

8. The electronic device according to claim 1, wherein the control circuit is configured to:
determine an orientation of the electronic device relative to a direction of a force of gravity; and
perform the detecting step only when the orientation of the electronic device is within a prescribed orientation relative to gravity.

9. The electronic device according to claim 1, wherein the control circuit is configured to:
detect linear acceleration data corresponding to a walking or running motion of the user; and
ignore such linear acceleration data.

10. The electronic device according to claim 1, wherein the controller is configured to:
determine an elapsed time between the detected linear acceleration or linear acceleration rate and a previously detected linear acceleration or linear acceleration rate;
determine whether a direction change occurred between the detected linear acceleration or linear acceleration rate and a previously detected linear acceleration or linear acceleration rate;
ignore the detected linear acceleration or linear acceleration rate when a direction change is detected and the elapsed time is less than a prescribed time period.

11. The electronic device according to claim 1, wherein the control circuit is configured to determine an intensity of the gesture based on the linear acceleration rate.

12. A method for detecting user inputs for an electronic device, comprising:
detecting at least one of a linear acceleration or a linear acceleration rate of the electronic device; and
correlating the detected linear acceleration or linear acceleration rate to a gesture for controlling the electronic device.

13. The method according to claim 12, wherein correlating includes determining a direction of the gesture based on a direction of the linear acceleration.

14. The method according to claim 12, wherein detecting at least one of the linear acceleration or linear acceleration rate comprises at least one of:
ignoring linear acceleration data that is below a prescribed threshold acceleration; or
ignoring linear acceleration data corresponding to a gait of a user.

15. The method according to claim 12, wherein detecting at least one of linear acceleration or linear acceleration rate comprises ignoring linear acceleration data that is not within a prescribed range of directions.

16. The method according to claim 12, wherein detecting at least one of linear acceleration or linear acceleration rate comprises:
determining an orientation of the electronic device relative to a direction of a force of gravity; and
performing the detecting step only when the orientation of the electronic device is within a prescribed orientation relative to gravity.

17. The method according to claim 12, wherein detecting at least one of linear acceleration or linear acceleration rate comprises detecting linear acceleration data corresponding to a walking or running motion of the user, and ignoring such linear acceleration data.

18. The method according to claim 12, further comprising performing the gesture on the skin of the user, wherein at least one of linear acceleration or linear acceleration rate of the electronic device corresponds to movement of the user's skin.

19. The method according to claim 12, wherein detecting at least one of linear acceleration or linear acceleration rate comprises:
determining an elapsed time between the detected linear acceleration or linear acceleration rate and a previously detected linear acceleration or linear acceleration rate;
determining whether a direction change occurred between the detected linear acceleration or linear acceleration rate and a previously detected linear acceleration or linear acceleration rate;
ignoring the detected linear acceleration or linear acceleration rate when a direction change is detected and the elapsed time is less than a prescribed time period.

20. The method according to claim 12, wherein correlating the detected linear acceleration or acceleration rate to a gesture for controlling the electronic device includes determining an intensity of the gesture based on the linear acceleration rate.
